(19) United States
(12) Patent Application Publication
(10) Pub. No.: US 2005/0186026 A1
(43) Pub. Date: Aug. 25, 2005

(54) Device for securing an object

(75) Inventor: Martin Heitlinger, Ostringen-Odenheim (DE)

Correspondence Address: W. MICHAEL DIXON;Patent Department, DEERE & COMPANY, One John Deere Place, Moline, IL, 61265-8098, US

(73) Assignee: Deere & Company, a Delaware corporation

(21) Appl. No.: 11/064,663

(22) Filed: Feb. 24, 2005

(30) Foreign Application Priority Data
Feb. 24, 2004 (DE) 10 2004 008 949.3

(51) Int. Cl. F16B 21/18

(52) U.S. Cl. 403/229

(57) ABSTRACT

The invention relates to a device for securing an object, the device being comprised of a locking bolt and a securing spring, the spring being securely attached to a first end region of the locking bolt. The securing spring extends in a generally U-shaped or arcuate path from the first end region of the locking bolt to a second end region of the locking bolt and thereby in the operating state extends around an object on one side of said object. The proposed device is comprised either of one piece or of multiple pieces that are coherently interconnected. The device provides releasability, and is easy to handle and manipulate. For this purpose the securing spring is capable of being reversibly secured to the second end region of the locking bolt.

### FIELD OF THE INVENTION

The present invention relates generally to a device for securing an object. More particularly, the device is comprised of a locking bolt and a securing spring, wherein the spring is securely attached to a first end region of the locking bolt. The securing spring extends in a generally U-shaped or arcuate path from the first end region of the locking bolt to a second end region of the locking bolt and thereby in an operating state extends around an object on one side of the object.

### BACKGROUND OF THE INVENTION

German Patent 300,802 discloses a wire cotter pin or the like which has a spring-loaded securing bend. This pin (or bolt) is ordinarily inserted in a bore in an object, to secure the object against rotation or against displacement with respect to a second object connected to the first object. This known device presents problems in that it can be used only for securing small objects, because when the bolt is being inserted or when the device is rotated the arcuate part must be swung out against the spring force. For example, the known device cannot be used to secure a catch element of a coupling hook of a type disclosed in DE 39 12 404 C1, against opening, because the bore in such an object is relatively far from the external region of the coupling hook. With such an application, it has been necessary to resort to use of a hexagonal-head threaded bolt and locking nut. A disadvantage of this latter solution is that in order to release the object one must remove the nut from the bolt; in agricultural applications in particular this carries the risk that one of the two pieces will be lost in the field.

Accordingly, the underlying problem of the present invention is to devise (with refinements) a device of the type described initially above, whereby the above-described problems are eliminated. In particular, the proposed device must either have only one piece or if it has multiple pieces the pieces must be coherently interconnected, and the device must provide releasability, and must be easy to handle and manipulate.

### SUMMARY OF THE INVENTION

According to the invention, the device includes a locking bolt and a securing spring, the spring being securely attached to a first end region of the locking bolt. The securing spring extends in an essentially U-shaped or arcuate path from the first end region of the locking bolt to a second end region of the locking bolt and thereby in the operating state extends around an object on one side of said object. The securing spring can be reversibly secured to the second end region of the locking bolt.

The generally U-shaped or arcuate region of the securing spring can extend around the object on one side and one can still accomplish securing of an object because, in contrast to the situation with the securing device disclosed in German Patent 300,802, the securing of an object is not accomplished exclusively with the aid of the spring force of the securing spring. The U-shaped or arcuate region can be formed so as to be adapted to a given application or task. A principal distinction of the securing of an object achieved with the invention is that it occurs by means of reversible securing of the securing spring to the second end region of the locking bolt. This reversible securing of the securing spring can be achieved, e.g., by engaging an appropriately configured region of the securing spring with the locking bolt. If the securing accidentally becomes released, the characteristics of the securing spring—particularly the pre-stressing thereof—act to prevent the locking bolt from sliding out of the corresponding bore.

The locking bolt preferably has a generally cylindrical or prismatic (rectangular, triangular, quadratic, polygonal etc.) shape. It can have a generally greater diameter than the cotter pin known from German Patent 300,802. Thus the inventive device advantageously enables securing of relatively large objects.

Reversible securing can be realized via an eye-shaped end region of the securing spring, the end region being configured such that in the secured state of the device, the end region substantially engages around (or surrounds) the second end region of the locking bolt. In this connection, the inner diameter of the eye-shaped end region is equal to or slightly greater than the outer diameter of the locking bolt. It is possible to improve the engagment around the locking bolt if, in the secured state of the device, the eye-shaped configuration of the end region of the securing spring engages a groove or recess provided on the end region of the locking bolt, the groove or recess preferably extending in the circumferential direction (peripheral direction). In this case the inner diameter of the eye-shaped end region is equal to or slightly greater than the outer diameter of the groove region of the locking bolt. This effectively prevents movement of the eye-shaped end region of the securing spring along the longitudinal axis of the locking bolt.

It is preferred that the eye-shaped end region of the securing spring has an generally U-shaped region (the minor U-shaped region) with legs a distance apart that is approximately equal to the outer diameter of the locking bolt or to the outer diameter of the groove provided on the end region of the locking bolt. In other words, in this particular case, one has an eye structure which is open on one side, the eye structure being directed toward the major U-shaped or arcuate part of the securing spring. This configuration of the end region of the securing spring is particularly economical to fabricate. The dimension of the legs of the minor U-shaped region may correspond to the basic outer diameter of the locking bolt or to the basic outer diameter of the groove formed on the end region of the locking bolt, to provide for surrounding or engaging around the locking bolt. As the dimension of the legs of the minor U-shaped region is increased, the likelihood of accidental disengagement of the securing becomes increasingly small.

Additionally, one end region of the securing spring has a curved region which has a radius of curvature that is greater than the basic outer diameter of the locking bolt. With this configuration, in order to achieve securing the securing spring can be bent out of engagement, such that the end region of the securing spring with this curved region is movable over the locking bolt, so that the minor U-shaped region can be brought into engagement with the groove.

According to an alternative embodiment, the reversible securing can be realized with the aid of a bore provided on the second end region of the locking bolt, so that the end region of the securing spring can be inserted into the bore. The bore may extend transversely to the longitudinal direction of the locking bolt, and may have, e.g., the same orientation as the part of the securing spring which comes to rest against or comes into engagement with the second end region of the locking bolt. Preferably, the end region of the securing spring has a generally straight shape, so that this end of the securing spring can be relatively easily inserted into the bore of the locking bolt. The bore may have an initial conical region at the side at which the securing spring is inserted into the bore, to facilitate the insertion of the end of the securing spring.

The locking bolt and the securing spring may be comprised of one piece. However, if the diameter of the locking bolt is greater than that of the securing spring, it may be advantageous for the device to have two pieces, particularly to facilitate the spring action of the securing spring. In this configuration, the securing spring is wound spirally at least once around the locking bolt in the first end region of the locking bolt. With this configuration the inner diameter of the spring winding generally corresponds to the outer diameter of the locking bolt.

The end of the securing spring may have a bent end member which can be clampingly held in a recess provided in the locking bolt, the recess extending transversely to the longitudinal direction of the locking bolt. Such a connection advantageously prevents loss of the spring or bolt, and also enables economical fabrication.

It is also possible to engage the securing spring to the locking bolt with the aid of a bore in the first end region of the locking bolt, the bore extending generally transversely to the longitudinal direction of the locking bolt, through which bore the end of the securing spring extends. It may further be provided that the securing spring is welded to the locking bolt, and/or that the securing spring is clampingly held in the bore. Alternatively or in addition, the securing spring may project to some extent outside of the bore, when inserted in the bore, and, e.g., this projection may have a 90° bend or may be wound in one loop around the locking bolt. This arrangement of the device can be fabricated at a particularly low cost.

According to a particularly preferred feature, the securing spring has a spring element which enables, but urges against, an opening movement of the arc or bend (e.g. major U-shaped configuration) formed by the securing spring. This spring element can thus enhance the basic spring action provided by the securing spring, and as a result of the increased pre-stressing it becomes largely impossible for the bolt to slide out or fall out of the bore in which it is installed, even when the securing spring is in the un-secured state.

The spring element may be disposed and/or configured such that it urges the end region of the securing spring to approach or be positioned at the first end of the locking bolt. This feature facilitates the manipulation of the inventive device, because it enables the securing to be accomplished easily and without tools.

Preferably the securing spring is configured such that it is urged closed when the securing spring undergoes an opening movement. Even in the face of a substantial distention or opening of the spring element, the spring element will be returned to its original shape.

In order to ensure that the securing spring (and/or spring element) will always be returned to its original shape, the spring element is dimensioned such that Hooke's Law applies, at least regarding the opening movement.

The spring element may comprise at least one loop (spiral loop or winding) of the securing spring. A spring element according to this feature is particularly economical to fabricate. It is particularly preferred to provide four spiral loops, intended to ultimately produce a particular spring constant (depending on the properties of the material of which the securing spring is comprised). The spring element is (or the windings are) preferably disposed in a region of the securing spring which is opposite to the locking bolt.

Preferably, a spiral loop (or loops) lies/lie in a plane which is generally parallel to the plane in which the major arc or bend of the securing spring lies. Alternatively, the loop(s) may lie in a plane which is generally orthogonal to the plane in which the major arc or bend of the securing spring lies.

To acquaint persons skilled in the art most closely related to the present invention, embodiments of the invention that illustrates the best mode now contemplated for putting the invention into practice are described herein by and with reference to, the annexed drawings that form a part of the specification. The exemplary embodiments are described in detail without attempting to show all of the various forms and modifications in which the invention might be embodied. As such, the embodiments shown and described herein are illustrative, and as will become apparent to those skilled in the art, can be modified in numerous ways within the spirit and scope of the invention—the invention being measured by the appended claims and not by the details of the specification.

### BRIEF DESCRIPTION OF THE DRAWINGS

For a complete understanding of the objects, techniques, and structure of the invention reference should be made to the following detailed description and accompanying drawings, wherein:

FIG. 1 is a perspective view of an exemplary embodiment of the inventive securing device, in the secured state;

FIG. 2 is a perspective view of the exemplary embodiment of FIG. 1 in an un-secured state;

FIG. 3 is an alternative perspective view of the exemplary embodiment of FIG. 2, wherein for the sake of clarity the spring is shown partly opened;

FIG. 4 is a perspective view of the securing device according to FIGS. 1 to 3, installed in a gripping device of a lower link bar of a tractor.

FIG. 5 is a plan view of an alternative embodiment of a securing device according to the invention; and,

FIG. 6 is a plan view of another alternative embodiment of a securing device according to the invention.

### DESCRIPTION OF THE PREFERRED EMBODIMENT

In the Figures the same or similar components are marked with like reference numerals.

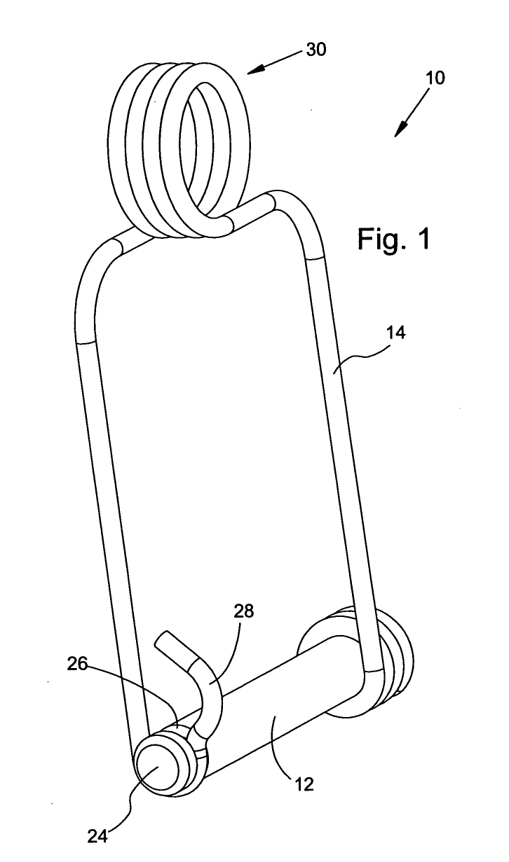

FIGS. 1 to 3 illustrate an exemplary embodiment of a device 10 for securing an object. The device 10 generally comprises a cylindrically shaped locking bolt 12 and a securing spring 14.

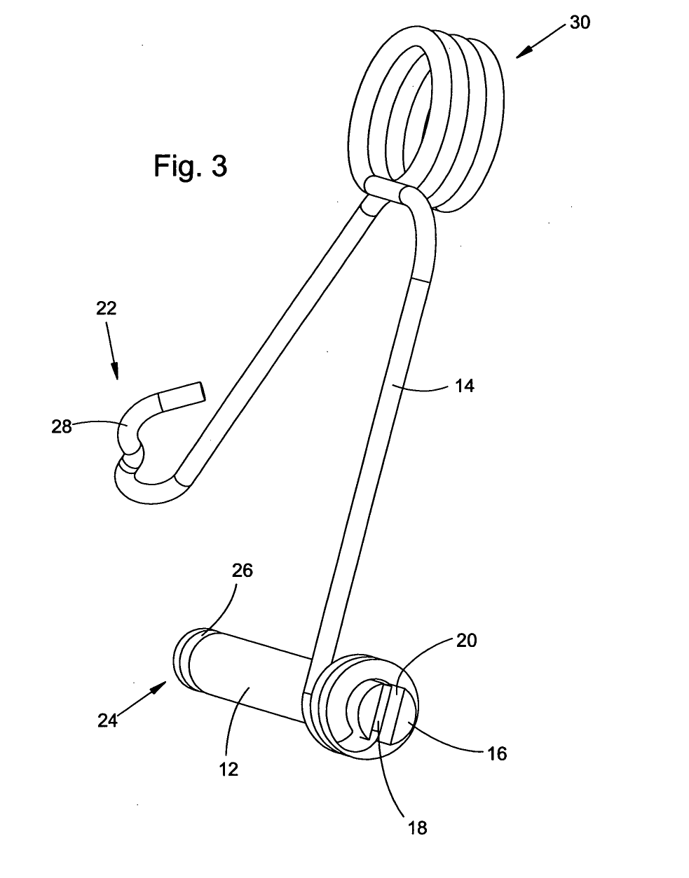

The securing spring 14 is securely attached to a first end region 16 of the locking bolt 12, as seen particularly in FIG. 3. This attachment is accomplished via a threefold loop of the securing spring 14 around the first end region 16 of the locking bolt 12 in combination with a bent end member 18 at the end of the securing spring 14. The bent end member 18 is held by clamping action in the recess 20, the recess extending generally transversely to the longitudinal direction of the locking bolt 12 and having a width which is slightly greater than the external diameter of the bent end member 18 of the securing spring 14.

For installing the securing spring 14 on the locking bolt 12, the spiral-shaped end region of the securing spring 14 is pushed (or slid) over the locking bolt 12 and is oriented such that the bent end member 18 is disposed in the recess 20, as illustrated in FIG. 3. Then the first end region 16 of the locking bolt 12 is compressed so as to clampingly hold the bent end member 18 in the recess 20. This achieves a fixed attachment of the securing spring 14 to the locking bolt 12, in a simple, economical, and effective manner.

The other end of the securing spring 14 comprises a bent region 22 (minor U-shaped region) which serves for reversible securing of the securing spring 14 to the locking bolt 12. In the secured state, the bent region 22 at least partially surrounds and engages the locking bolt 12, and generally has the shape of an eye. At the second end region 24 of the locking bolt 12, a groove 26 is provided which is engaged by the bent region 22 of the securing spring 14 in the secured state (FIG. 1). The groove 26 is not as deep as the outer diameter of the securing spring 14 in the bent region 22. Accordingly, the inner radius of the bent region 22 essentially corresponds to the outer radius of the region of the locking bolt 12 on which the groove 26 is provided. The groove 26 is slightly wider than the outer diameter of the securing spring 14 in the bent region 22. The bent region is essentially U-shaped in the region in which it engages the groove 26. As a result of this configuration of the second end region 24 of the locking bolt in coordination with the bent region 22 of the securing spring 14, the bent region 22 cannot be moved along the longitudinal axis of the locking bolt when in the secured state.

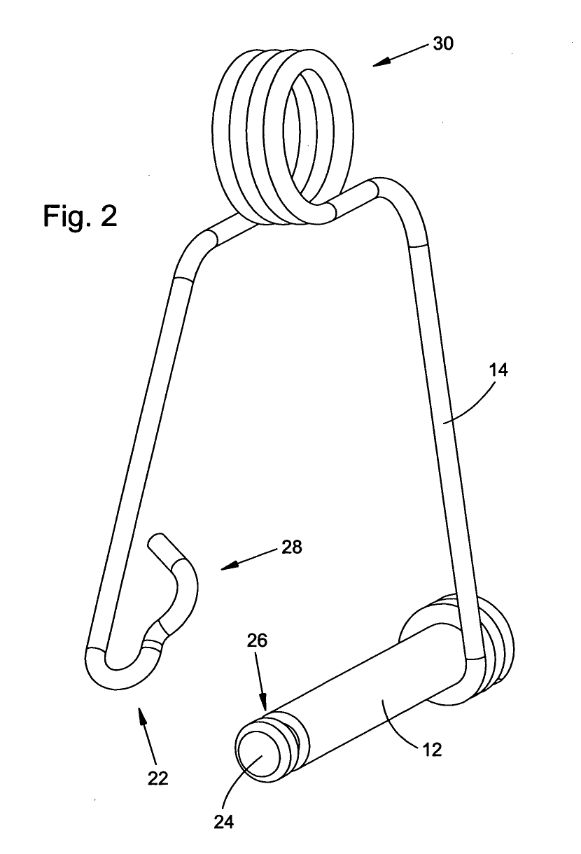

The bent region 22 also comprises a curved region 28 which has an inner radius that is greater than the basic outer diameter of the locking bolt 12. To secure the securing spring 14 (FIG. 2), the free end of the securing spring 14 must be swung or otherwise brought into proximity with the second end region 24 of the locking bolt 12, such that the free end of the securing spring 14 with its curved region 28 can be slid over (or pushed over) the locking bolt 12. As soon as the curved region 28 reaches the region of the groove 26, as a result of the appropriate spring-loaded pre-stressing of the end region 22, it automatically moves such that the U-shaped region of the bent region 22 (the minor U-shaped region) engages the groove 26. To release the securing, the opposite procedure is carried out. In this manner, one can advantageously employ the inventive device to secure objects, accomplishing securing and releasing without the use of tools.

The securing spring 14 has a spring element 30 comprised of four loops of the material of the securing spring 14. The loops are oriented such that they lie in a plane which is generally parallel to the plane in which the major U-shaped (or arcuate) part of the securing spring 14 lies. In this way the spring element 30 is disposed in a region of the major U-shaped (or arcuate) part of the securing spring 14 which is opposite to the locking bolt 12. The spring element 30 is adjusted so as to oppose an opening movement of the free end of the securing spring 14. An opening movement of up to 180° is possible without problems under this arrangement, but generally an opening movement of 90° suffices when mounting the device on an object. The windings (loops) of the spring element 30 are configured so that when the securing spring 14 is moved in an opening movement the spring element tends to close (draw together). The spring constant of the spring element 30 should be chosen such that one can open the securing spring 14 up to 180° without problems, and that Hooke's Law applies to movement in that range of opening movement.

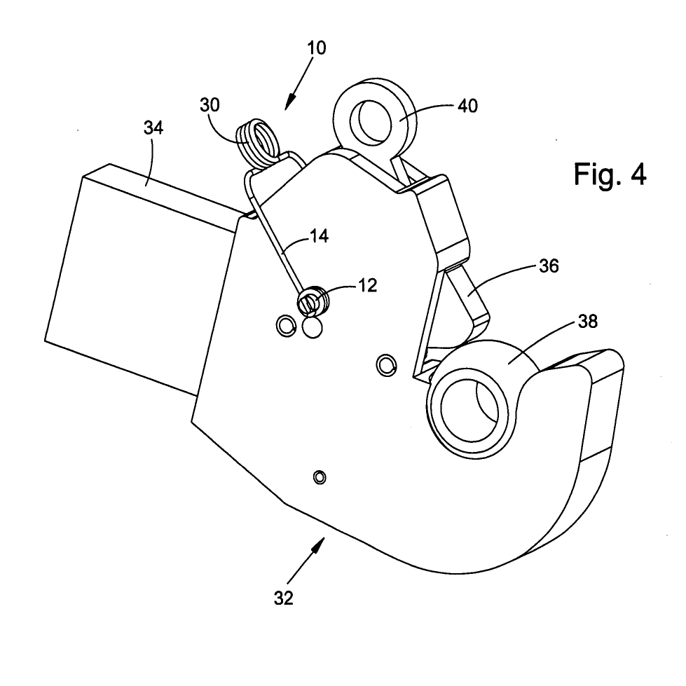

FIG. 4 illustrates the application of the device 10 on a gripping device 32 of a lower link bar 34 (the link bar shown only in part), which may be disposed, e.g., on a three-point hitch structure on a tractor. The gripping device 32 comprises a catch member 36 whereby a spherical bearing element 38 can be secured to the gripping device 32. The bearing element 38 is typically associated with the coupling device of a processing machine (not shown in FIG. 4). The catch member 36 can be disengaged via the actuating member 40, but only if the locking bolt 12 does not extend through the housing openings of the gripping device 32. In the position of the gripping device shown in FIG. 4, the catch member 36 is locked in place. It can be seen from FIG. 4 that the securing spring 14 is nearly optimally configured for use with the gripping device of the given form. The configuration of the invention with the securing spring 14 ensures that even if the locking bolt 12 is not in the secured state the locking bolt cannot be readily removed from the housing of the gripping device 32, because the free end 22 of the securing spring 14 presses against the housing of the gripping device 32, as a result of the spring properties of the securing spring 14 in cooperation with the spring element 30.

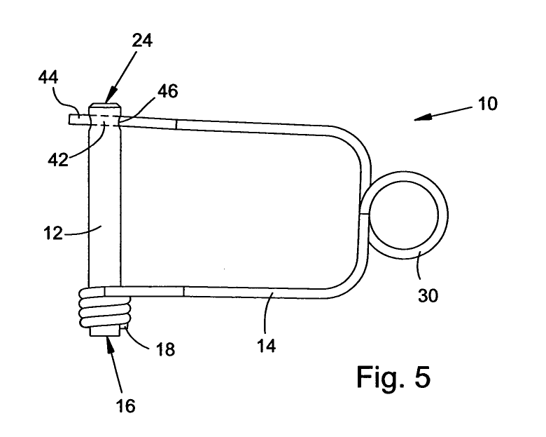

According to the embodiment shown in FIG. 5, reversible securing is realized with the aid of a bore 42 provided on the second end region 24 of the locking bolt 12, so that the end region of the securing spring 14 can be inserted into the bore 42. The bore 42 extends transversely to the longitudinal direction of the locking bolt 12, and has the same orientation as the part of the securing spring 14 which comes to rest against or comes into engagement with the first end region 16 of the locking bolt 12. Preferably, the end region 44 of the securing spring 14 has a generally straight shape, so that this end 44 of the securing spring 14 can be relatively easily inserted into the bore 42 of the locking bolt 12. The bore 42 may have an initial conical region 46 at the side at which the securing spring 14 is inserted into the bore 42, to facilitate the insertion of the end 44 of the securing spring 14.

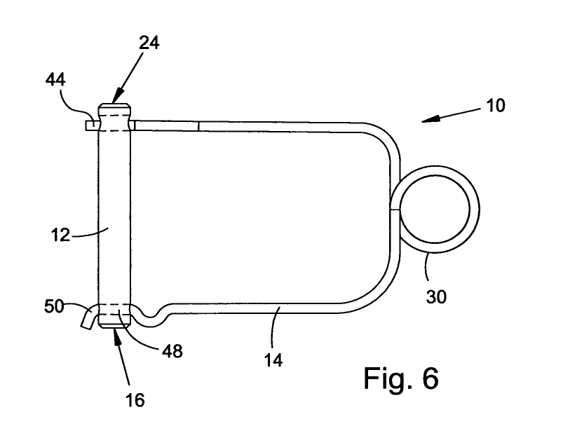

According to the embodiment shown in FIG. 6, an engagement between the securing spring 14 and the locking bolt 12 is realized with the aid of a bore 48 in the first end region 16 of the locking bolt 12. The bore 46 extending generally transversely to the longitudinal direction of the locking bolt 12, through which bore 46 the end 50 of the securing spring 14 extends. The securing spring 14 might be welded to the locking bolt 12. Alternatively, as shown in FIG. 6, the securing spring 14 is clampingly held in the bore 48. The securing spring 14 projects with the end 50 to some extent outside of the bore 48, when inserted in the bore 48. This arrangement of the device can be fabricated at a particularly low cost.

Thus it can be seen that the objects of the invention have been satisfied by the structure presented above. While in accordance with the patent statutes, only the best mode and preferred embodiments of the invention have been presented and described in detail, it is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A device for securing an object, the device comprising a locking bolt and a securing spring, the spring being securely attached to a first end region of the locking bolt and extending in a generally U-shaped or arcuate path from the first end region of the locking bolt to a second end region of the locking bolt and thereby in the operating state extends around an object on one side of the object, wherein the securing spring has a spring element that enables, but urges against, an opening movement of the arc or bend formed by the securing spring and the securing spring can be reversibly secured to the second end region of the locking bolt.

2. A device according to claim 1 wherein the locking bolt has a generally cylindrical shape.

3. A device according to claim 1 wherein the locking bolt has a generally prismatic shape.

4. A device according to claim 1 wherein the reversible securing is established by an eye-shaped configuration of an end region of the securing spring, that in the secured state of the device substantially surrounds the second end region of the locking bolt.

5. A device according to claim 4 wherein in the secured state of the device, the eye-shaped configuration of the end region of the securing spring engages a groove provided on the end region of the locking bolt, the groove extending generally in the circumferential direction.

6. A device according to claim 4 wherein the eye-shaped end region of the securing spring has a minor U-shaped region with legs a distance apart that is approximately equal to the outer diameter of the locking bolt or to the outer diameter of the groove provided on the end region of the locking bolt.

7. A device according to claim 6 wherein the dimension of the legs of the minor U-shaped region corresponds to the basic outer diameter of the locking bolt or to the basic outer diameter of the groove provided on the end region of the locking bolt.

8. A device according to claim 4 wherein one end region of the securing spring has a curved region which has a radius of curvature that is greater than the basic outer diameter of the locking bolt.

9. A device according to claim 1 wherein the reversible securing is achieved by a bore provided in the second end region of the locking bolt, so that the end region of the securing spring can be inserted into the bore, and wherein the bore extends transversely to the longitudinal direction of the locking bolt.

10. A device according to claim 1 wherein the securing spring is wound spirally at least once around the locking bolt in the first end region of the locking bolt; and wherein the end of the securing spring has a bent end member that can be clampingly held in a recess provided in the locking bolt, the recess extending generally transversely to the longitudinal direction of the locking bolt.

11. A device according to claim 1 wherein the first end region of the locking bolt has a bore which extends generally transversely to the longitudinal direction of the locking bolt, through which bore the end of the securing spring extends and a part of the securing spring projects to some extent outside of the bore, and the projecting part of the securing spring has a bend or arc, so that the securing spring is disposed in and clampingly held in said bore.

12. A device according to claim 1 wherein the spring element urges the end region of the securing spring to be positioned at the first end of the locking bolt.

13. A device according to claim 1 wherein the spring element is configured such that it is urged closed when the securing spring undergoes an opening movement.

14. A device according to claim 1 wherein the spring element is dimensioned such that Hooke's Law applies, with regard to the opening movement.

15. A device according to claim 1 wherein the spring element comprises at least one spiral loop of the securing spring, and is disposed in a region of the securing spring opposite the locking bolt.

16. A device according to claim 15 wherein the at least one loop lies in a plane which is generally parallel to the plane in which the major U-shaped or arcuate part of the securing spring lies.

17. A device according to claim 15 wherein the at least one loop lies in a plane which is generally orthogonal to the plane in which the major U-shaped or arcuate part of the securing spring lies.
